(19) United States
(12) Patent Application Publication
(10) Pub. No.: US 2024/0278469 A1
(43) Pub. Date: Aug. 22, 2024

(54) A METHOD FOR CONTROLLING AN INJECTION MOLDING MACHINE

(71) Applicant: LEGO A/S, Billund (DK)

(72) Inventors: Rasmus Aagaard HERTZ, Billund (DK); Jesper Kjærsgaard CHRISTENSEN, Billund (DK); Nikolai Lønbro SVALEBÆK, Billund (DK); Michael KNUDSEN, Billund (DK)

(73) Assignee: LEGO A/S, Billund (DK)

(21) Appl. No.: 18/570,295

(22) PCT Filed: Jun. 29, 2022
(86) PCT No.: PCT/EP2022/067845

§ 371 Date: Dec. 14, 2023

(30) Foreign Application Priority Data
Jun. 30, 2021 (DK) PA202170339

(51) Int. Cl. B29C 45/76

(52) U.S. Cl. CPC B29C 45/766; B29C 2945/76006; B29C 2945/76066; B29C 2945/76545

(57) ABSTRACT

A method for controlling an injection molding machine comprising a reciprocating plasticizing screw and a controller system adapted for measuring or calculating at least one first production parameter and for controlling/setting at least one second production parameter on the injection molding machine. The method comprises setting a preselected target value for the first production parameter, and inputting the target value into the controller system. The method comprises comparing the measured first production parameter of one production cycle with the preselected target value for the first production parameter. The method comprises calculating by the controller system a new value for the second production parameter as a function of the difference between the first production parameter and the preselected target value for the selected actual production parameter. The method comprises setting by the controller system said new value for the second production parameter for a subsequent production cycle.

### CROSS REFERENCE TO RELATED APPLICATIONS

The present application is a U.S. National Stage Application of International Application No. PCT/EP2022/067845, filed on Jun. 29, 2022 and published on Jan. 5, 2023 as WO 2023/275120 A1, which claims the benefit and priority of Danish Patent Application No. 202170339, filed on Jun. 30, 2021, each of which is incorporated herein by reference in its entirety for any purpose whatsoever.

### FIELD OF THE DISCLOSURE

The present disclosure relates to a method for controlling an injection molding machine comprising a reciprocating plasticizing screw and a controller system adapted for measuring a first production parameter or calculating the first production parameter based upon an input signal from a sensor arranged on the injection molding machine and for controlling/setting a second production parameter on the injection molding machine.

### BACKGROUND

In conventional injection molding tools it is very common to control different parameters of the injection molding process in order to obtain a stable molding process so the functionality of the produced parts, such as weight, function and tolerances are within a certain range.

Nevertheless many factors influences the production environment over time for the injection molding machine, and therefore it is desired to control that various production parameters does not drift over time due to these influences.

In this relation variations of e.g. the dosage time that the injection molding machine uses to produce a specific amount of molten plastic ready for injection may vary especially during open loop processing due to e.g. varying percentages of regrind plastic material used during the production cycles. These variations of the dosage may give rise to reduced quality of the products produced or even to different errors in the molding process.

### SUMMARY

Based on this, it is the object of the present disclosure to provide a simple and reliable method for controlling that various production parameters does not drift over time.

This is obtained by a method according to claim 1 specifying:
a. setting a preselected target value for said first production parameter, and inputting said target value into the controller system
b. comparing by the controller system the measured first production parameter of one production cycle with said preselected target value for said first production parameter
c. calculating by the controller system using a mathematical function between the first production parameter and the second production parameter a new value for said second production parameter as a function of the difference between the first production parameter and the preselected target value for said selected actual production parameter
d. setting by the controller system said new value for the second production parameter on the injection molding machine for a subsequent production cycle.

In a preferred embodiment the setting by the controller system of the new value for the second production parameter for the subsequent production cycle is performed so that that the difference between the first production parameter for the subsequent production cycle and the preselected target value for the first production parameter is reduced.

The setting by the controller system of said new value for the second production parameter for a subsequent production may be made to affect any subsequent production cycle, but in a preferred embodiment it is performed for the production cycle immediately following the first production cycle.

The mathematical function may be updated during production e.g. using machine learning, but it may advantageously be predefined and in an especially simple embodiment of the disclosure the mathematical function is linear. It is, however, apparent to the skilled person that also other mathematical functions may be used.

The calculating of a new value for said second production parameter may advantageously comprise restricting that the difference between the previous value for said second production parameter and new value for said second production parameter does not exceed a predefined value.

In one aspect of the disclosure the first production parameter is the injection time, and the second production parameter is the injection flow rate.

In another aspect of the disclosure the first production parameter is the so-called cushion defined e.g. by the position of the reciprocating plasticizing screw after injection, and the second production parameter is the plasticization volume.

In yet another aspect of the disclosure the first production parameter is the pressure integral, or part integral of the injection pressure profile and the second production parameter is the target injection pressure or holding pressure.

In yet another aspect of the disclosure the first production parameter is the actual dosage time for the reciprocating plasticizing screw to plasticize a preselected volume of plastic material, and the second production parameter is the speed of rotation of the reciprocating plasticizing screw.

The present disclosure also relates to an injection molding machine comprising a reciprocating plasticizing screw and a controller system adapted for measuring or calculating a selected actual production parameter on the injection molding machine and for controlling another production parameter on the injection molding machine and where the controller system is adapted for performing the method according to one or more of the preceding claims.

### BRIEF DESCRIPTION OF THE DRAWINGS

Various aspects of the present disclosure are discussed herein with reference to the accompanying Figures. It will be appreciated that for simplicity and clarity of illustration, elements shown in the drawings have not necessarily been drawn accurately or to scale. For example, the dimensions of some of the elements can be exaggerated relative to other elements for clarity or several physical components can be included in one functional block or element. Further, where considered appropriate, reference numerals can be repeated among the drawings to indicate corresponding or analogous elements. For purposes of clarity, however, not every component can be labeled in every drawing. The Figures are provided for the purposes of illustration and explanation and are not intended as a definition of the limits of the disclosure.

FIG. 1 is a flowchart showing a control flow for a production cycle of an injection molding machine according to the disclosure.

FIG. 2 is a principle drawing showing an injection molding machine with a control system adapted for controlling dosage time.

FIG. 3 is a chart showing exponential weighted moving average weight as a function of cycles from current cycle n.

FIG. 4 is a chart showing dosage time as a function of screw speed.

### DETAILED DESCRIPTION

The subject technology overcomes many of the prior art problems associated with controlling injection molding machine. The advantages, and other features of the technology disclosed herein, will become more readily apparent to those having ordinary skill in the art from the following detailed description of certain exemplary embodiments taken in combination with the drawings and wherein like reference numerals identify similar structural elements. It should be noted that directional indications such as vertical, horizontal, upward, downward, right, left and the like, are used with respect to the figures and not meant in a limiting manner.

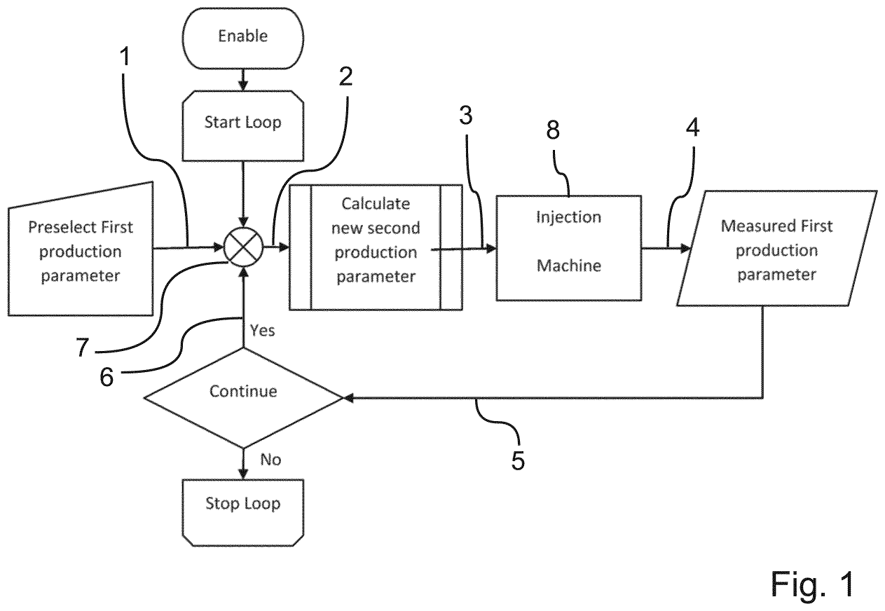

FIG. 1 is a flowchart showing a closed loop control cycle according to the disclosure, where a preselected target value 1 is first set for a first production parameter, then the preselected target value is during a later production cycle compared by a comparator with at least one previously measured first production parameter, and based upon the difference 2 between the previously measured 5, 6 and the preselected target value 1 a new second production parameter 3 is calculated in order to reduce or eliminating the difference 2 between the previously measured 5, 6 and the preselected target value 1 of the subsequent production cycle. The new second production parameter is then set on the injection molding machine 8, and a new value for the measured first production parameter 5, 6 is returned to the comparator 7 for the next cycle.

It will be apparent to the skilled person, and especially in view of the embodiment described below as an example, that many different production parameters may be controlled using basic principle if it is possible to establish a mathematical relation between the first and the second production parameter.

One example is where the first production parameter is the injection time, and the second production parameter is the injection flow rate.

Another example is where the first production parameter is the position of the reciprocating plasticizing screw after injection (cushion), and the second production parameter is the plasticization volume.

Yet another example is where the first production parameter is the pressure integral, or part integral of the injection pressure profile and the second production parameter is the target injection pressure or holding pressure.

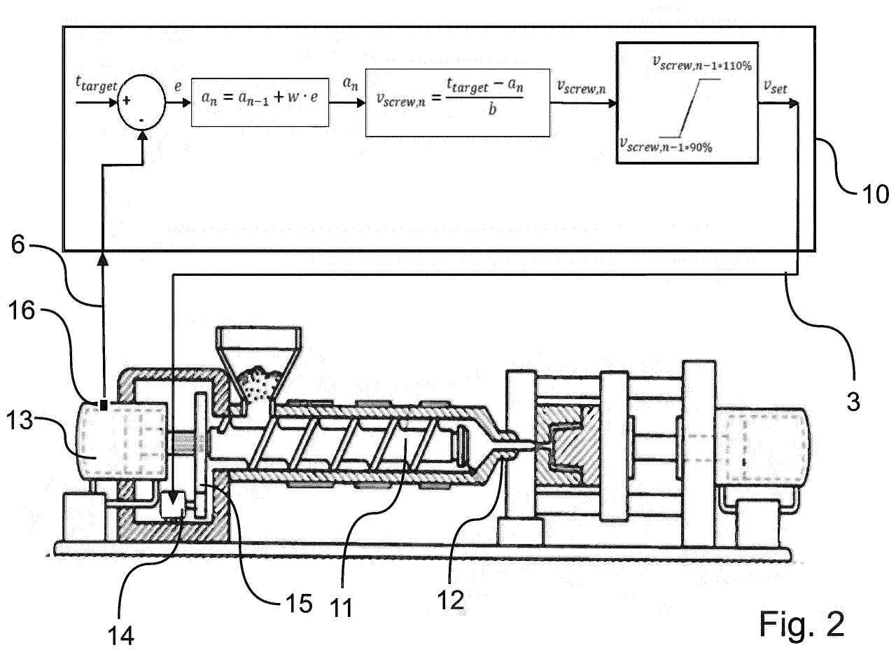

FIG. 2 shows yet another example of an embodiment of the disclosure shown in FIG. 1 where an Injection molding machine comprises a reciprocating plasticizing screw 11 adapted for plasticizing plastic material in a barrel and for forcing a volume of plastic via a nozzle 12 and into a mold. In this embodiment the reciprocating action of the plasticizing screw 11 is driven by a hydraulic cylinder (RAM) 13 and its rotation is driven by a motor 14 via a gear 15.

In order to monitor the dosage time a position sensor 16 is arranged on the RAM 13.

The controller 10 is adapted to, based upon the first production parameter being the actual dosage time for the reciprocating plasticizing screw to plasticize a preselected volume of plastic material, to control the second production parameter being the speed of rotation of the reciprocating plasticizing screw during the plasticizing process.

In relation to this embodiment of the disclosure multiple tests have showcased an assumable linear relation between the screw rotation and the dosage time. The relation is described as a linear equation. It could also be described as a nonlinear equation and linearized afterwards:

$${t}_{dos} = β \cdot {v}_{s c r e w} + α + {e}_{m o d}$$

Where α and β are constants and e is the error.

Utilizing the \hat{ }(hat) notation it is possible to estimate the true behavior by:

$${\hat{t}}_{dos} = b \cdot {v}_{s c r e w} + a$$

Where \hat{t}_{dos} is the predicted dosage time, and a and b are predicted parameters of α and β.

There are multiple ways to implement the control action, by keeping a and b constant or updating them both or individually. If the intersect term a is selected and only one set of data is present a will be estimated as:

$$a = {\hat{t}}_{dos} - b \cdot {v}_{s c r e w}$$

If the gain term b is selected it will be estimated as:

$$b = \frac{{\hat{t}}_{dos} - a}{{v}_{s c r e w}}$$

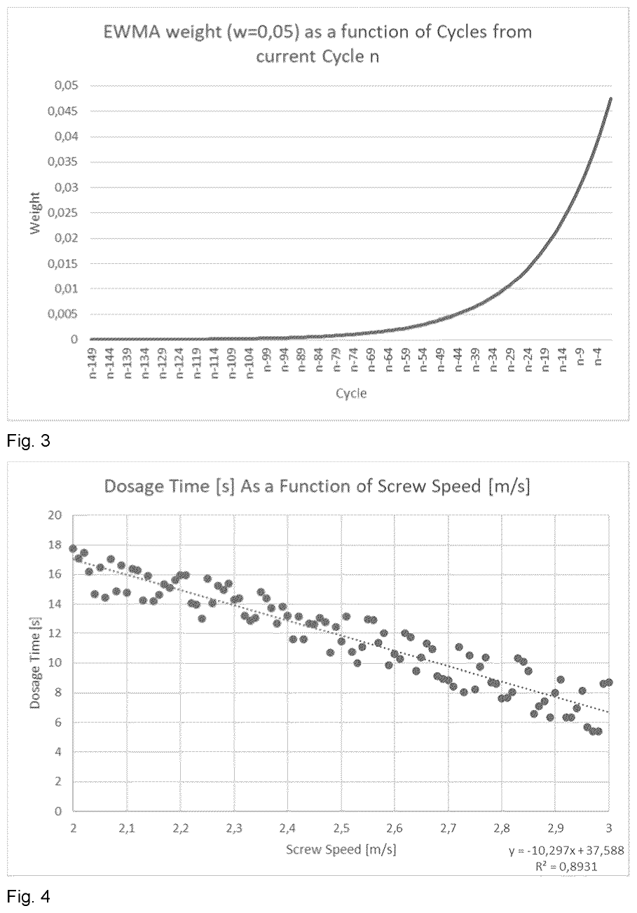

In the following, and as shown in FIG. 3, it is chosen to update the intersect term a. As noise is present in any measurement it is desired to use multiple previous measurement where the last measurement should have the most weight. The Exponential Weighted Moving Average (EWMA) has these features. EWMA at cycle n

$$WEIGHT ( n ) = {w ( 1 - w )}^{n - 1}$$

As can be seen in FIG. 4, a model of such is estimated through experimentation. The model changes dependent on factors such as regrind. In the demonstrated it is chosen to keep b constant and update a as that is where the biggest change was seen in the experimental data.

The control loop will then be created minimizing the error between a target value and the actual value:

$$e = {t}_{target} - {t}_{actual}$$

The input is updated according to:

$${v}_{screw , n} = \frac{{t}_{target} - {a}_{n - 1}}{b}$$

The routine updating a is defined as:

$${a}_{n} = {\sum }_{i = 1}^{n} {w ( 1 - w )}^{n - i} \cdot ( {y}_{i} - b \cdot {x}_{i} )$$

In recursive form it can be described as:

$${a}_{n} = w ( {t}_{dos} - b \cdot {v}_{screw , n} ) + ( 1 - w ) {a}_{n - 1}$$

In the special case where the input parameter is updated for each cycle and utilizing the ν_{screw,n} estimation equation it is possible to rewrite to:

$${a}_{n} = w ( {t}_{dos} - b \cdot \frac{{t}_{target} - {a}_{n - 1}}{b} ) + ( 1 - w ) {a}_{n - 1}$$

It can be reduced to:

$${a}_{n} = {a}_{n - 1} + w \cdot e$$

It is clear that the modelled value for a becomes stationary as the error between actual and target value goes to zero meaning the model is similar or identical to the real system and the output t_{dos} is controllable. As this is a simple kind of controller it will be apparent to the skilled person that only three parameters have to be estimated and tuned. b being constant, a updating according to the algorithm and w needs to be tuned.

It will be appreciated by those of ordinary skill in the pertinent art that the functions of several elements can, in alternative embodiments, be carried out by fewer elements, or a single element. Similarly, in some embodiments, any functional element can perform fewer, or different, operations than those described with respect to the illustrated embodiment. Also, functional elements shown as distinct for purposes of illustration can be incorporated within other functional elements in a particular embodiment.

While the subject technology has been described with respect to various embodiments, those skilled in the art will readily appreciate that various changes and/or modifications can be made to the subject technology without departing from the scope of the present disclosure.

What is claimed is:

1. A method for controlling an injection molding machine comprising a reciprocating plasticizing screw and a controller system adapted for measuring or calculating at least one first production parameter based upon input signals from at least one sensor arranged on the injection molding machine and for controlling/setting at least one second production parameter on the injection molding machine, wherein the method comprises:
a. setting a preselected target value for the first production parameter, and inputting the target value into the controller system;
b. comparing, by the controller system, the measured first production parameter of one production cycle with the preselected target value for the first production parameter;
c. calculating, by the controller system, using a mathematical function between the first production parameter and the second production parameter, a new value for the second production parameter as a function of the difference between the first production parameter and the preselected target value for the selected actual production parameter; and
d. setting by the controller system the new value for the second production parameter on the injection molding machine for a subsequent production cycle.

2. The method according to claim 1, further comprising setting by the controller system the new value for the second production parameter for the subsequent production cycle in order to ensure that the difference between the first production parameter for the subsequent production cycle and the preselected target value for the first production parameter is reduced.

3. The method according to claim 1, wherein the setting by the controller system of the new value for the second production parameter for a subsequent production cycle is performed for the production cycle immediately following the first production cycle.

4. The method according to claim 1, wherein the mathematical function is a predefined linear function.

5. The method according to claim 1, wherein the calculating of a new value for the second production parameter comprises restricting that the difference between the previous value for the second production parameter and new value for the second production parameter does not exceed a predefined value.

6. The method according to claim 1, wherein the first production parameter is the injection time, and the second production parameter is the injection flow rate.

7. The method according to claim 1, wherein the first production parameter is the position of the reciprocating plasticizing screw after injection (cushion), and the second production parameter is the plasticization volume.

8. The method according to claim 1, wherein the first production parameter is the pressure integral, or part integral of the injection pressure profile and the second production parameter is the target injection pressure or holding pressure.

9. The method according to claim 1, wherein the first production parameter is the actual dosage time for the reciprocating plasticizing screw to plasticize a preselected volume of plastic material, and where the second production parameter is the speed of rotation of the reciprocating plasticizing screw during the plasticizing process.

10. An injection molding machine comprising a reciprocating plasticizing screw and a controller system adapted for measuring or calculating a selected actual production parameter on the injection molding machine and for controlling another production parameter on the injection molding machine and where the controller system is adapted for performing the method according to claim 1.

11. A method for controlling an injection molding machine comprising a reciprocating plasticizing screw and a controller system, the method comprising the steps of:
preselecting a target value for a first injection molding production parameter of the injection molding machine;
calculating, with the controller system, a second injection molding production parameter based on the target value of the first injection molding production parameter and a previously measured first injection molding production parameter;
inputting, with the controller system, the calculated second injection molding production parameter into the injection molding machine; and
measuring, with the controller system, an actual first injection molding production parameter.

12. The method according to claim 11, wherein the first injection molding production parameter is an injection time of the injection molding machine, and the second injection molding production parameter an injection flow rate of the injection molding machine.

13. The method according to claim 11, wherein the first injection molding production parameter is a position of a reciprocating plasticizing screw within the injection molding machine after injection, and the second injection molding production parameter is a plasticization volume.

14. The method according to claim 11, wherein the first injection molding production parameter is a pressure integral of an injection pressure profile of the injection molding machine, and the second injection molding production parameter is a target injection pressure or holding pressure of the injection molding machine.

15. The method according to claim 11, wherein the first injection molding production parameter is a dosage time of a reciprocating plasticizing screw in the injection molding machine to plasticize a preselected volume of plastic material, and the second injection molding production parameter is a speed of rotation of the reciprocating plasticizing screw.

16. The method according to claim 11, wherein the first injection molding production parameter is linearly related to the second injection molding production parameter.

17. A method for controlling an injection molding machine comprising a reciprocating plasticizing screw and a controller system, the method comprising the steps of:
preselecting a target value for a dosage time of a reciprocating plasticizing screw in the injection molding machine to plasticize a preselected volume of plastic material;
calculating, with the controller system, a speed of rotation of the reciprocating plasticizing screw based on the target value and a previously measured dosage time of the reciprocating plasticizing screw;
inputting, with the controller system, the calculated speed of rotation of the reciprocating plasticizing screw into the injection molding machine; and
measuring, with the controller system, an actual dosage time of the reciprocating plasticizing screw.
